(19) United States
(12) Patent Application Publication
(10) Pub. No.: US 2025/0269336 A1
(43) Pub. Date: Aug. 28, 2025

(54) HYDRODYNAMIC CAVITATION MIXER

(71) Applicant: FOWE ECO SOLUTIONS LTD., Majuro (MH)

(72) Inventors: Branko VUGRINEC, Monaco (MC); Franjo KUSEC, Opatija (HR)

(21) Appl. No.: 18/859,804

(22) PCT Filed: Aug. 30, 2022
(86) PCT No.: PCT/EP2022/074085

§ 371 Date: Oct. 24, 2024

(30) Foreign Application Priority Data
Apr. 29, 2022 (GB) 2206341.6

(51) Int. Cl. B01F 25/441; B01F 23/41; B01F 23/411; B01F 23/45; B01F 25/433; B01F 101/00; B01F 101/07; B01F 101/40

(52) U.S. Cl. CPC B01F 25/4413; B01F 23/4105; B01F 23/4111; B01F 23/4143; B01F 23/4145; B01F 23/45; B01F 25/4335; B01F 2101/07; B01F 2101/40; B01F 2101/505; B01F 2215/0431; B01F 2215/0468; B01F 2215/0477

(57) ABSTRACT

A mixer for fluid is described. The mixer comprises a housing. The housing comprises an inlet and an outlet, wherein the housing further comprises first and second portions, the first portion being of a substantially cylindrical internal shape of constant radius R₁, and the second portion being of a substantially conical frustum internal shape of varying radius between R₁ and R₂, wherein R₁<R₂. A spindle is rigidly fixed within the housing, and comprises first and second portions, the first portion being of a substantially conical frustum shape of varying radius between r₁ and r₂, where r₁<r₂, and the second portion being of a substantially cylindrical shape of radius r₂. At least part the first portion of the spindle is housed within the first portion of the housing, and at least part of the second portion of the spindle is housed within the second portion of the housing.

### BACKGROUND

An emulsion is a mixture of two or more liquids, which are not soluble in each other. Emulsions of two liquids consist of a dispersed phase and a continuous phase, with the dispersed phase (e.g. water in an oil and water emulsion) distributed in the continuous phase (e.g. oil in an oil and water emulsion). The boundary between the two phases is referred to as the interface. The stability of an emulsion refers to the ability of the emulsion over time to resist the stratification of the dispersed and continuous phases of the emulsion.

Emulsified fuels, produced from an emulsion of fuel oil and water, may be used in some applications to provide environmental benefits, such as a reduction in soot emissions from emulsion-powered engines, and a reduction in the emission of nitrous oxide gases (NOx).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A mixer for fluid is described. The mixer comprises a housing. The housing comprises an inlet and an outlet, wherein the housing further comprises first and second portions, the first portion being of a substantially cylindrical internal shape of constant radius R₁, and the second portion being of a substantially conical frustum internal shape of varying radius between R₁ and R₂, wherein R₁<R₂. A spindle is rigidly fixed within the housing, and comprises first and second portions, the first portion being of a substantially conical frustum shape of varying radius between r₁ and r₂, where r₁<r₂, and the second portion being of a substantially cylindrical shape of radius r₂. At least part the first portion of the spindle is housed within the first portion of the housing, and at least part of the second portion of the spindle is housed within the second portion of the housing.

A first aspect provides a mixer for one or more fluids that uses hydrodynamic cavitation, the mixer comprising: a housing, comprising at least one fluid inlet and at least one fluid outlet, wherein the housing further comprises a first portion and a second portion, the first portion being of a substantially cylindrical internal shape of constant radius R₁, and the second portion being of a substantially conical frustum internal shape of varying radius between R₁ and R₂, wherein R₁<R₂, and a spindle, rigidly fixed within the housing, wherein the spindle comprises a first portion and a second portion, the first portion being of a substantially conical frustum shape of varying radius between r₁ and r₂, where r₁<r₂, and the second portion being of a substantially cylindrical shape of radius r₂; wherein at least part the first portion of the spindle is housed within the first portion of the housing, and at least part of the second portion of the spindle is housed within the second portion of the housing.

The first portion of the housing and the second portion of the spindle may share a common longitudinal axis.

The inlet may be is in fluid communication with the first portion of the housing.

The outlet may be in fluid communication with the second portion of the housing.

The value of r₂ may be less than R₁.

The value of r₁ may be 5 mm.

The value of r₂ may be 10.5 mm.

The value of R₁ may be 11.8 mm.

The length of the first portion of the spindle along the longitudinal axis may be 39 mm.

The length of the second portion of the spindle along the longitudinal axis may be 55 mm.

The length of the housing may be between 150 to 200 mm.

The combined weight of the housing and the spindle may be less than 15 kg.

A second aspect provides an apparatus comprising a plurality of mixers as described herein.

A third aspect provides a method of mixing a fluid using hydrodynamic cavitation, comprising the steps of: inputting a fluid, via an inlet, to a first portion of a housing comprising a first portion of a spindle, wherein the first portion of the housing is of a substantially cylindrical internal shape of constant radius R₁, and the first portion of the spindle is of a substantially conical frustum shape of varying radius between r₁ and r₂, where r₁<r₂, accelerating the fluid around the first portion of the spindle, mixing at least a portion of the fluid via a hydrodynamic cavitation process, passing the mixed flued to a second portion of the housing comprising a second portion of the spindle, wherein the second portion of the housing is of a substantially conical frustum internal shape of varying radius between R₁ and R₂, wherein R₁<R₂, and the second portion of the spindle is of a substantially cylindrical shape of radius r₂; decelerating the mixed fluid, outputting the mixed fluid via an outlet.

The fluid may comprise one or more of: fuel oil; diesel; jet fuel; lubricating oil; grease; and cream.

The fluid may comprise a first fluid and a second fluid, wherein the mixed fluid is an emulsion, and wherein mixing at least a portion of the fluid via a hydrodynamic cavitation process comprises: emulsifying at least a portion of the first fluid and the second fluid to form an emulsion via a hydrodynamic cavitation process.

The first fluid may be one of: fuel oil; diesel; jet fuel; lubricating oil; grease; or cream.

The second fluid may be water.

The fluid may be input at a pressure of between 1 to 20 bar.

The mixed fluid may be output at a pressure of between 6 to 8 bar.

The fluid may be accelerated to between 45 to 55 times its speed when input, optionally to 50 times its speed when input.

The time taken between the inputting of the fluid, and the outputting of the mixed fluid (i.e. the time taken for fluid to pass through the mixer from the inlet to the outlet), may be less than 0.01 seconds.

Where the fluid output is an emulsion, the emulsion may comprise particles of the second fluid, wherein the particles of the second fluid are approximately 1-3 microns in diameter.

Where two fluids are input, the acceleration of the second fluid may cause at least a portion of the second fluid to evaporate.

Where the fluid output is an emulsion, the emulsion may remain in a stable state for more than 12 months.

A further aspect provides a method of emulsifying two or more fluids using hydrodynamic cavitation, comprising the steps of: inputting a first fluid and a second fluid, via an inlet, to a first portion of a housing comprising a first portion of a spindle, wherein the first portion of the housing is of a substantially cylindrical internal shape of constant radius R₁, and the first portion of the spindle is of a substantially conical frustum shape of varying radius between r₁ and r₂, where r₁<r₂, accelerating the first fluid and second fluid around the first portion of the spindle, emulsifying at least a portion of the first fluid and the second fluid to form an emulsion via a hydrodynamic cavitation process, passing the emulsion to a second portion of the housing comprising a second portion of the spindle, wherein the second portion of the housing is of a substantially conical frustum internal shape of varying radius between R₁ and R₂, wherein R₁<R₂, and the second portion of the spindle is of a substantially cylindrical shape of radius r₂; decelerating the emulsion, outputting the emulsion via an outlet.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a high-level overview of a mixer;

FIGS. 2A, 2B, 2C, 2D and 2E show cross-sectional views of an example of a mixer;

FIG. 3 shows a graphical representation of speed and pressure as a fluid passes through a mixer as described herein;

FIG. 4 is a further example of a spindle for use in a mixer as described herein;

FIG. 5A is an example of a mixer when integrated within a larger system; and

FIG. 5B is an example of a plurality of mixers when integrated within a larger system in parallel.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Hydrodynamic cavitation is a physical phenomenon that occurs in areas of strong pressure drop in liquids. Hydrodynamic cavitation is the result, in most cases, of sudden changes in the geometric shape of the pipeline and the built-in fittings through which the fluid passes. The consequence of hydrodynamic cavitation is a local rapid change in fluid pressure, the transition of the liquid phase to the gaseous and back to the liquid phase. Cavitation is relatively easy to produce, but very difficult to control and stop. The mixer described herein may be used to mix one or more fluids or to emulsify two or more fluids together. Emulsification may be considered to be the most complex form of mixture formation (i.e. the most complex form of mixing), which requires the greatest energy to cancel the existing physico-chemical characteristics between two liquids, which do not mix with each other. Emulsification creates new intermolecular energy relationships, which result in a stable emulsion. Conventionally, this is achieved by adding chemicals in the emulsion production process.

When the mixer described herein is used to emulsify two or more fluids together, the mixer allows for the production of stable emulsified fuels with water without additives and chemicals, using hydrocarbon fractions from diesel to the heaviest fuel oils. It is appreciated that other fluids may also be emulsified. In some examples, the emulsion produced using the mixer is sufficiently stable that it cannot be separated into its constituent liquids using a centrifuge.

The mixer as disclosed herein allows for more efficient and rapid mixing of liquids in all types of industries, with the immediate achievement of complete homogeneity, in a single pass through the mixer. The mixer does not require any fluids used to be pre-mixed in any particular way, nor for the provision of large storage tanks either before or after the fluid passes through the mixer. This allows for improved efficiency across an entire industrial process. The mixer itself provides a compact and portable design which may be more easily transported and installed within a larger system. The industries for which this mixer may be used include one or more of: shipping; food; construction; engineering; and/or pharmaceuticals.

The mixer may be used to produce a relatively long-term stable emulsion over a period between several months and several years, for example 12 months. Such an emulsion is “water in oil” type, produced without additional chemicals and without the need for further mixing plant.

Hydrodynamic cavitation is mostly in practice, an undesirable phenomenon, insufficiently scientifically researched area, without clear scientifically confirmed conclusions. Hydrodynamic cavitation is the result of sudden changes in the geometric shape of the fittings and the pipeline through which a fluid passes. For example, hydrodynamic cavitation can cause suction, fluid loss during pumping, power loss during propeller drive, and/or damage to metal surfaces of equipment.

Hydrodynamic cavitation releases a large amount of energy. At the molecular level, high pressures (1000 bar) and temperatures (5000 K) develop. Under these relatively extreme conditions, ions, free radicals, electron displacement, and the breaking of interatomic bonds occur. It is important to say that there is no manifestation of pressure and temperature to the outside, the pressure and temperature of the process is the same (normal).

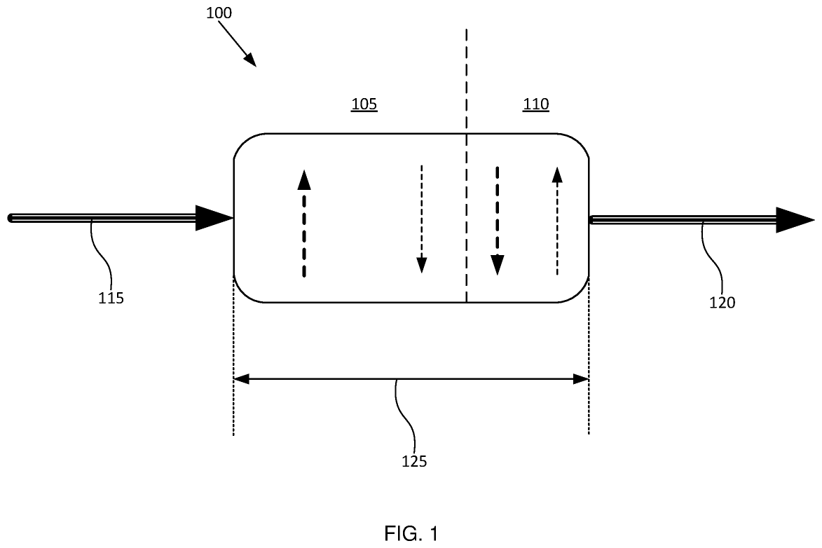

FIG. 1 is a high-level overview of a mixer (which may also be referred to as an agitator). In this example, the mixer is used as an emulsifier, although in other examples, the mixer may be used to mix a single input fluid (e.g. a single input fluid of fuel oil). There is shown a mixer 100, divided into two portions: a first portion 105, and a second portion 110. The first portion 105 is the portion in which controlled hydrodynamic cavitation takes place to produce an emulsion. The second portion 110 is the region in which hydrodynamic cavitation is ceased, and the resulting emulsion is output from the mixer 100.

In this example, a first and a second fluid enter the mixer 100 as demonstrated by path 115, at a pressure of between 8 to 10 bar. In the example described below, the first fluid is fuel oil and the second fluid is water; however, it will be appreciated that in other examples other oils (aside from fuel oil) may be used and/or other combinations of fluids may be used. In the first portion 105 of the mixer 100, the speed (V) of the fuel oil and water is raised to approximately 45 to 55 times, optionally 50 times, of that when compared with the speed at which the fuel oil and water was initially introduced to the mixer 100.

This increase in velocity results in a significant pressure drop (P), which causes water to evaporate (water=dispersed phase). Water in the gaseous state penetrates strongly and quickly into the fuel oil (fuel oil=continuous phase). Water as a gas ideally occupies the space inside the fuel oil, resulting in complete homogeneity of the emulsion.

In the second portion 110 of the mixer 100, the velocity of the liquid (liquid=emulsion) is reduced. Accordingly, the pressure increases, the emulsion exits the mixer 100 via path 120 under a pressure between 6 to 8 bar.

The distance between the input of the fluids to be emulsified 115 and the output of the emulsion 120 is represented by the distance arrow 125. This distance 125 may in one example be approximately 150 to 200 mm. In one example, the time taken for the fluids to enter the mixer 100, become at least partly emulsified, and exit the mixer 100 is approximately 0.01 seconds.

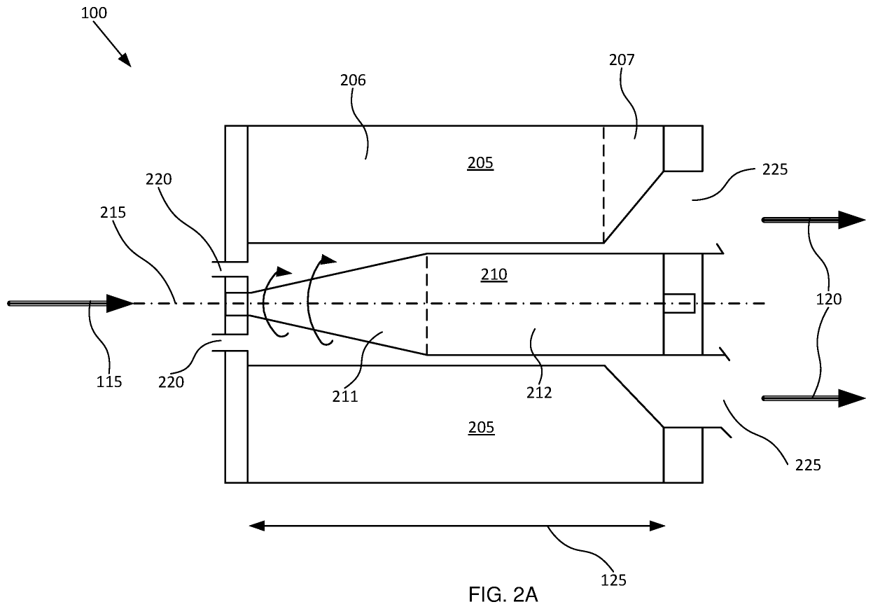

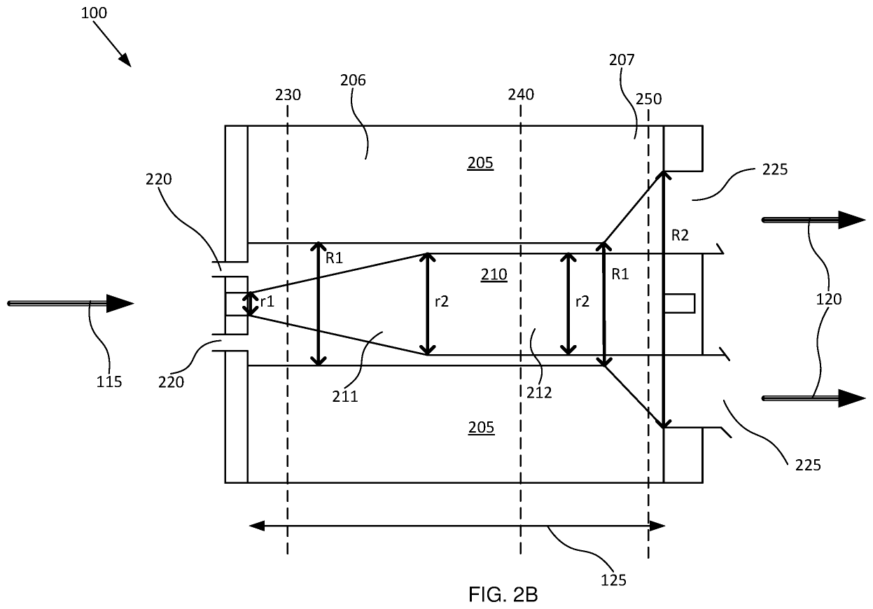

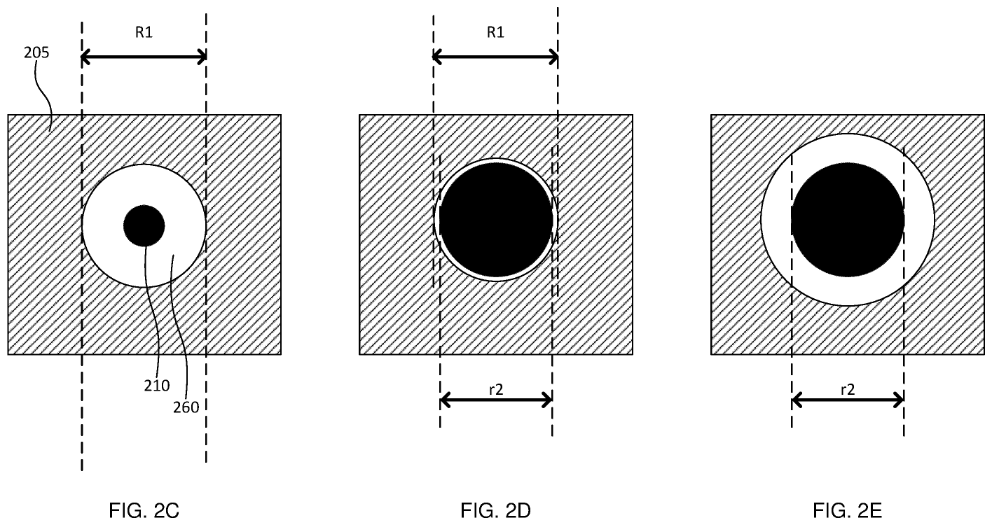

FIG. 2A shows a first cross-sectional view of an example of a mixer 100 and FIG. 2B shows the view as in FIG. 2A with the addition of dimension markings. In this example there is shown a housing 205, comprising a first housing portion 206 and a second housing portion 207. The first housing portion 206 encloses a substantially cylindrical recess of radius R₁ around the longitudinal axis 215. The second housing portion 207 encloses a recess substantially in the shape of a conical frustum, with a radius varying between R₁ and R₂, in fluid communication with the substantially cylindrical recess. It will be appreciated that whilst the housing 205 is described as comprising a first and a second housing portion this is for the purposes of defining its shape only and the housing may be manufactured as a plurality of pieces that are subsequently joined together, where the housing is divided into pieces in the same way or in a different way to the first and second housing portions.

The conical frustum enclosed by the second housing portion 207 has a first radius R₁ which is equal to the radius of the substantially cylindrical recess R₁, and a second radius R₂ at the opposing end from the cylindrical recess (and at the outlet end of the housing) which is greater than the radius R₁ of the substantially cylindrical recess. In such a way, the cross-sectional area of the total recess formed by the housing 205 broadens as the fluid 115 passes through the mixer 100.

The housing 205 also substantially encloses a spindle 210. The spindle 210 is rigidly fixed within the housing 205, via protrusions from the first spindle portion 211 and the second spindle portion 212, which are rigidly fixed to the housing 205 from each end of the spindle 210. The spindle 210 comprises a first spindle portion 211 (at an end proximate the inlets 220 to the housing 205) and a second spindle portion 212 (at an end proximate to the outlets 225 from the housing 205). The first spindle portion 211 is substantially in the shape of a conical frustum, with a smaller radius r₁ at the point at which fluid 115 is introduced to the mixer 100, and a larger radius r₂ at the point at which the first spindle portion 211 meets the second spindle portion 212.

The second spindle portion 212 is of a substantially cylindrical shape, with a radius r₂ similar to the larger radius r₂ of the first spindle portion 211. The first spindle portion 211 is housed at least partly within the first housing portion 206, and the second spindle portion 212 is housed at least partly within the second housing portion 207.

The spindle 210 and the cavities 260 within the housing 205 of this example both have rotational symmetry about the longitudinal axis 215, as shown in FIGS. 2C-2E. FIGS. 2C, 2D and 2E show cross-sectional views perpendicular to that shown in FIGS. 2A and 2B and taken at the positions shown with the dotted lines 230, 240 and 250 respectively in FIG. 2B.

As the spindle 210 of this example is fixed within the housing 205, the emulsion apparatus 100 does not have any moving parts, including any rotationally moving parts. This increases the reliability and functional longevity of the emulsion apparatus 100, as well as allowing for a less energy intensive installation process and no need for any supplementary power input. The fluid 115 of this or any other example may be introduced to the mixer 100 substantially in line with the longitudinal axis of one or more parts of the housing 205 and/or spindle 210.

The spindle 210 of the or each of the examples provided may be formed from a single piece of material, such as metal. The spindle 210 of the or each of the examples provided may lack any radial protrusions. Instead, the spindle 210 may have a substantially smooth external surface, comprising the first spindle portion 211 in the shape of a conical frustum joined to the second spindle portion 212 of a cylindrical shape. Hydrodynamic cavitation can impose significant temperatures and pressures on internal components. By providing a spindle 210 without radial protrusions, and integrally formed from the two solid shapes of the first spindle portion 211 and second spindle 212, the spindle 210 provides a robust (and hence reliable) and easy to manufacture component.

The spindle and the housing may be made from carbon steel.

During use, liquid 115 is introduced into the mixer 100 via one or more inlets 220. As shown in FIGS. 2A and 2B, one or more inlets 220 are parallel to the longitudinal axis 215 of the spindle. In the example, liquid 115 of this example contains water and fuel oil (water and any hydrocarbon fraction from diesel to heavy fuel oils). As described above, the mixer described here can be used for all types of liquids in all branches of industry. Water and fuel oil are two immiscible liquids, regardless of any pressure or temperature. Upon entry into the mixer 100, the fluid 115 makes contact with the first spindle portion 211. The fluid 115 rotates around the first spindle portion 211, enclosed between the outer surface of the first spindle portion 211 and an inner surface of the first housing portion 206. The rotation of the fluid 115 is caused by the shape of the first spindle portion 211 and the inner surface of the first housing portion 206, and not by any external factor or force. Hence there is no need to pressurise the fluid significantly before entry into the mixer 100, nor provide any additional power sources to rotate the fluid 115 around the spindle. In such a way, power consumption of the mixer is reduced, and in some examples may be reduced by a factor of 10 when compared to conventional mixing devices. The only power source required is for a pump to push the fluid 115 into the mixer 100, which may be powered in some examples using an electric motor.

The rotation of the fluid around the first spindle portion 211, also corresponding to rotation around the longitudinal axis 215, causes a strong and sudden increase in fluid velocity. The rotation continues along at least a portion of the second spindle portion 212, with the fluid remaining enclosed between the second spindle portion 212 and the inner surface of the first housing portion 206.

This sudden increase in fluid velocity causes a reduction in pressure. The drop in pressure causes the liquid water of this example to evaporate, and penetrate into the fuel oil. This high-speed travel of the fluid 115 continues until the fluid has reached the end of the inner surface of the first housing portion 206.

The fluid, an emulsion of fuel oil and water, continues to rotate between the second portion of the spindle 212 and the second portion of the housing 207. However, at the point where the second portion of the housing 207 begins, the fluid decreases velocity and increases pressure accordingly. The fluid of this example, now an emulsion 120 of fuel oil and water, is output from the mixer 100 via one or more outlets 225. As shown in FIGS. 2A and 2B, like the inlets 220, the one or more outlets 225 are parallel to the longitudinal axis 215 of the spindle.

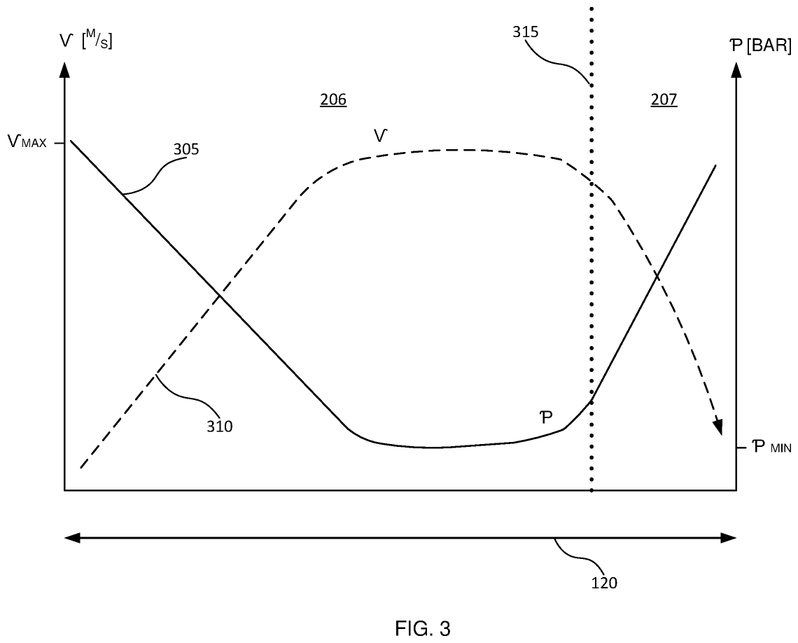

FIG. 3 shows a graphical representation of velocity (V) and pressure (P) as the liquid passes through the mixer. The left vertical axis represents the fluid velocity, shown by the dashed line 310. The right vertical axis represents the fluid pressure, shown by the solid line 305. Both fluid velocity and fluid pressure are shown along the length 120 of the mixer 100.

The left hand section of the graph, until the vertical dotted line 315, shows the speed of the fluid and pressure of the fluid while the fluid is in contact with the inner surface of the first housing portion 206. In this left hand section of the graph, the speed of the fluid increases linearly until the fluid reaches the end of the first spindle portion 211. At that point, when the fluid is enclosed between the second spindle portion 212 and the inner surface of the first housing portion 206, the speed plateaus around a maximum speed V_{MAX}.

Concurrently, the pressure P decreases linearly until the fluid reaches the end of the first spindle portion 211. At that point, when the fluid is enclosed between the second spindle portion 212 and the inner surface of the first housing portion 206, the pressure plateaus around a minimum pressure P_{MIN}.

Once the fluid reaches the end of the first housing portion 206, represented by the vertical dotted line 315, the fluid has at least party formed into an emulsion. The velocity 305 of this emulsion drops linearly, until a similar velocity to that of the fluid when it entered the mixer 100 is reached, as the emulsion exits the mixer 100.

Concurrently, the pressure 315 of the emulsion rises linearly until the emulsion exits the mixer 100, until a similar pressure to that of the fluid when it entered the mixer 100 is reached. An entry and exit pressure of between 5 to 10 bar may be used for emulsification in the production of emulsified fuels, such as a mix of fuel oil and water. Such emulsions may be used as a fuel for power stations and/or ships. Water emulsified fuel has a lower content of carbon and sulphur, thereby in use reducing emissions of carbon dioxide, nitrogen oxides (NOx), sulphur oxides (Sox), and/or particular matter such as dust or smoke.

It is possible to reduce the sulphur content in such an emulsion of fuel oil and water, above the percentage of added water. This is due to the cracking of the relatively weak bond between the carbon and sulphur atoms. The additional stability of such an emulsion is due to the dipole character of the water molecule, as well as the very small water particles in the emulsion, approximately 1-3 microns in size. Therefore, the mass of the water particle is practically negligible, which eliminates the effect of gravity and thus contributes to the stability of the emulsion.

The achieved complete homogeneity of the emulsion of fuel oil and water from this example is the result of mutually correctly oriented poles of water molecules in the emulsion, in accordance with the polarity. In that way, the emulsion is stronger due to the electrical interaction of the opposite poles of water molecules. As an analogy, an emulsion can be considered structurally reinforced, with electrical threads (like reinforced concrete). Evidence of the high stability of the emulsion created using the mixer described herein is that even at 120° C., no evaporation of water from the emulsion occurred.

Inlet and outlet pressures between 6-10 bar can be used to produce water emulsified fuels. To increase the conversion of lighter, more valuable products, refinery processes use an inlet pressure of 8-20 bar.

The mixer 100 may additionally or alternatively be used for the process of blending. In such a use case, an entry and exit pressure of between 1 to 7 bar may be used for when performing blending processes, to provide a substantially complete homogenization in a single pass through the mixer 100. A blending process refers to any mixing or combining of one or more fluids, and may include the more specific process of emulsification. Such blending may be used for one or more of: diesel, jet fuel, lubricating oils, greases, and/or creams. By using such a blending process lower consumption of additives may be achieved when compared with conventional means of blending. In some examples up to a 40% reduction in additives is required. Such additives may be provided to enhance the stability of the mixed product. In some cases, the mixing of fuel alone can provide benefits, such as the amelioration of the fuel recipe, and/or the breakdown of long chain molecules

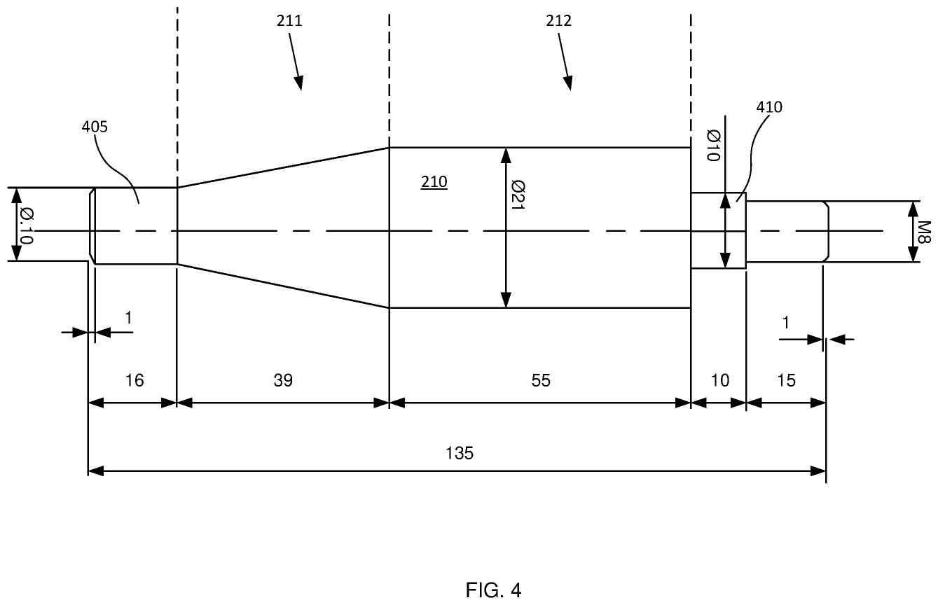

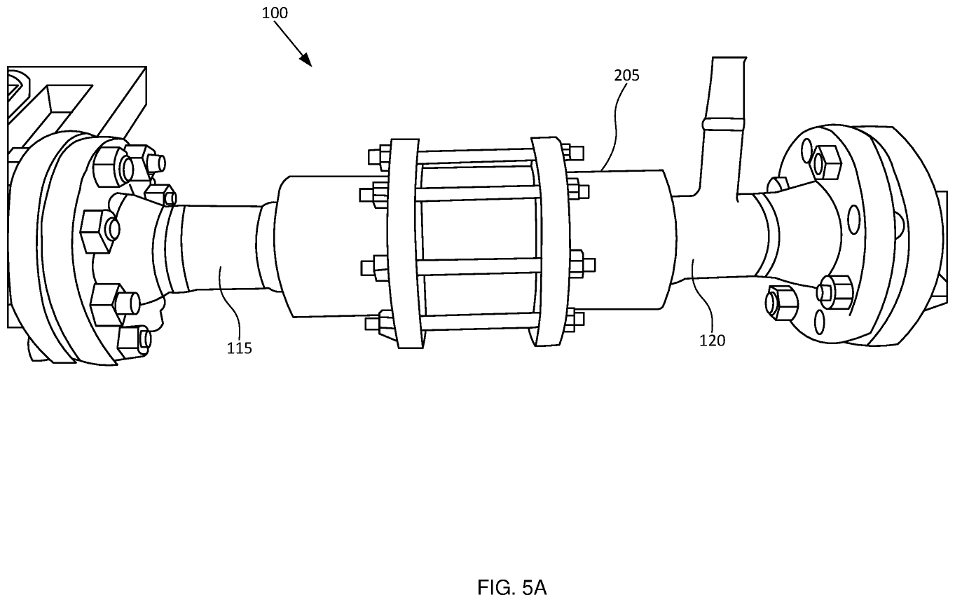

FIG. 4 is a further example of a spindle 210 as described above. In this example, the spindle 210 remains formed from a first spindle portion 211 and a second spindle portion 212. The first spindle portion 211 has substantially a conical frustum shape, varying linearly from a diameter of 10 mm (r₁=5 mm) to a diameter of 21 mm (r₂=10.5 mm). The first spindle portion 211 is connected to a chamfered connecting rod 405 of 16 mm length and 10 mm diameter, with a chamfered portion of 1 mm length. The chamfered connecting rod 405 is used to fix the spindle 210 within a housing. A spindle as shown in FIG. 4 may, for example, be used in a housing with a cylindrical recess of diameter 22.8 mm (R₁=11.4 mm). The recess within the housing may open up, at the outlet end such that the maximum diameter of the recess in the housing is 94 mm (R₂=47 mm).

Remote from the chamfered connecting rod 405 is the second spindle portion 212. This second spindle portion 212 is of a cylindrical shape, of a constant diameter of 21 mm and length 55 mm. The second spindle portion 212 is connected to a second connecting rod 410, used to fix the spindle 210 within the housing. The second connecting rod 410 comprises a first cylinder of diameter 10 mm and length 10 mm connected to the second spindle portion 212. The second connecting rod 410 also comprises a second cylinder of diameter 8 mm and length 15 mm connected to the first cylinder. It is appreciated that these dimensions refer only to a single example of the spindle 210, and other spindles may be formed with alternative dimensions provided that the ratios between the different parts of the spindle 210 are dimensioned to allow sufficient mixing of fluids between the spindle 210 and the housing 205. The overall length of the spindle 210 of this example is 135 mm. The overall weight of the spindle 210 and housing 205 of this embodiment is approximately 10 to 20 kg, optionally less than 15 kg. The mixer can be connected to a fluid inlet via a 4 inch (approximately 100 mm) valve.

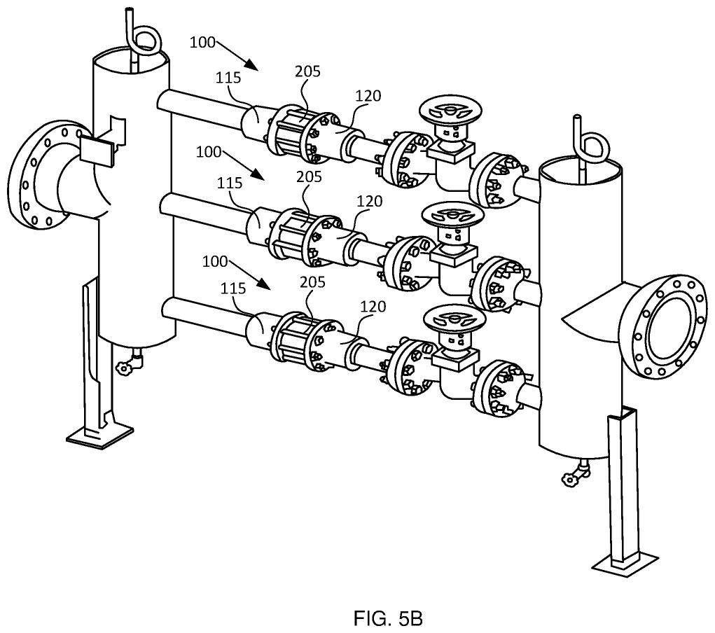

FIG. 5A is an example of a mixer when integrated into a larger system. In this example, the mixer 100 as shown in at least one preceding figure has been installed within a larger system, and is being used as an emulsifier. Two or more fluids 115 are provided to the housing 205 enclosing the spindle (not shown). The hydrodynamic cavitation and emulsification take place as the fluids travel between the spindle and the housing 205, and the resulting emulsion 120 is output from the apparatus.

FIG. 5B shows a plurality of mixers 100 installed in parallel to provide increased capacity. In the example shown in FIG. 5B, the input fluid is fuel (without water) and the use of the mixers serves to increase the recovery of lighter components in the refinery process. As with FIG. 5A, hydrodynamic cavitation takes place as the fluid travels between the spindle and the housing 205.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A mixer for one or more fluids that uses hydrodynamic cavitation, the mixer comprising:
a housing, comprising at least one fluid inlet and at least one fluid outlet, wherein
the housing further comprises a first portion and a second portion,
the first portion being of a substantially cylindrical internal shape of constant radius R₁, and the second portion being of a substantially conical frustum internal shape of varying radius between R₁ and R₂, wherein R₁<R₂, and
a spindle, rigidly fixed within the housing, wherein
the spindle comprises a first portion and a second portion,
the first portion being of a substantially conical frustum shape of varying radius between r₁ and r₂, where r₁<r₂, and
the second portion being of a substantially cylindrical shape of radius r₂; wherein
at least part of the first portion of the spindle is housed within the first portion of the housing, and at least part of the second portion of the spindle is housed within the second portion of the housing.

2. The mixer of claim 1, wherein the first portion of the housing and the second portion of the spindle share a common longitudinal axis.

3. The mixer of claim 1, wherein the inlet is in fluid communication with the first portion of the housing.

4. The mixer of claim 1, wherein the outlet is in fluid communication with the second portion of the housing.

5. The mixer of claim 1, wherein r₂<R₁.

6. The mixer of claim 1, wherein r₁ is 5 mm.

7. The mixer of claim 1, wherein r₂ is 10.5 mm.

8. The mixer of claim 1, wherein R₁ is 11.8 mm.

9. The mixer of claim 2, wherein a length of the first portion of the spindle along the longitudinal axis is 39 mm.

10. The mixer of claim 2, wherein a length of the second portion of the spindle along the longitudinal axis is 55 mm.

11. The mixer of claim 1, wherein a length of the housing is between 150 to 200 mm.

12. The mixer of claim 1, wherein a weight of the housing and a weight of the spindle combine to less than 15 kg.

13. An apparatus comprising a plurality of the mixers according to claim 1.

14. A method of mixing a fluid using hydrodynamic cavitation, comprising the steps of:
inputting a fluid, via an inlet, to a first portion of a housing comprising a first portion of a spindle, wherein
the first portion of the housing is of a substantially cylindrical internal shape of constant radius R₁, and the first portion of the spindle is of a substantially conical frustum shape of varying radius between r₁ and r₂, where r₁<r₂,
accelerating the fluid around the first portion of the spindle, mixing at least a portion of the fluid via a hydrodynamic cavitation process,
passing the mixed flued to a second portion of the housing comprising a second portion of the spindle, wherein
the second portion of the housing is of a substantially conical frustum internal shape of varying radius between R₁ and R₂, wherein R₁<R₂, and
the second portion of the spindle is of a substantially cylindrical shape of radius r₂;
decelerating the mixed fluid,
outputting the mixed fluid via an outlet.

15. The method of claim 14, wherein the fluid comprises at least one of the group consisting of: fuel oil, diesel, jet fuel, lubricating oil, grease, and cream.

16. The method of claim 14, wherein the fluid comprises a first fluid and a second fluid, wherein the mixed fluid is an emulsion, and wherein mixing at least a portion of the fluid via a hydrodynamic cavitation process comprises:
emulsifying at least a portion of the first fluid and the second fluid to form an emulsion via a hydrodynamic cavitation process.

17. The method of claim 16, wherein the first fluid is selected from the group consisting of: fuel oil, diesel, jet fuel, lubricating oil, grease, or and cream.

18. The method of claim 17, wherein the second fluid is water.

19. The method of claim 14, wherein the fluid is input at a pressure of between 1 to 20 bar.

20. The method of claim 14, wherein the mixed fluid is output at a pressure of between 6 to 8 bar.

21. The method of claim 14, wherein the fluid is accelerated to between 45 to 55 times its speed when input.

22. The method of claim 14, wherein a time taken between the inputting of the fluid, and the outputting of the mixed fluid, is less than 0.01 seconds.

23. The method of claim 16, wherein the emulsion comprises particles of the second fluid, wherein the particles of the second fluid are approximately 1-3 microns in diameter.

24. The method of claim 16, wherein the acceleration of the second fluid causes at least a portion of the second fluid to evaporate.

25. The method of claim 16, wherein the emulsion remains in a stable state for more than 12 months.
